(19) United States
(12) Patent Application Publication
(10) Pub. No.: US 2026/0116162 A1
(43) Pub. Date: Apr. 30, 2026

(54) Support assembly for an embedded rear cover

(71) Applicant: ZHEJIANG SURPASS AUTO PARTS CO.,LTD., Wenzhou City (CN)

(72) Inventors: Yi Lin, Wenzhou City (CN); Lei Lin, Wenzhou City (CN)

(21) Appl. No.: 19/013,427

(22) Filed: Jan. 8, 2025

(30) Foreign Application Priority Data
Oct. 30, 2024 (CN) 202411533149.6

(51) Int. Cl. B60J 7/14

(52) U.S. Cl. CPC B60J 7/141

(57) ABSTRACT

The present invention discloses a support assembly for an embedded rear cover, the support assembly is provided at a rotating shaft point of the folded car cover, the support assembly includes at least one of a first support structure and a second support structure, that support the folded body at the rotating shaft point to maintain the folded body in a state of support with respect to the rear cargo hopper. In present invention supports the front side and the rear side of the folded embedded rear cover through the first support structure and the second support structure, so as to support the folded embedded rear cover in an all-round manner and enhance the solidity of the support. Further, by matching the clamp groove with the first support structure, the steps in the support process are simplified by simply attaching the clamping surface to the surface to be clamped.

### CROSS-REFERENCE TO RELATED APPLICATIONS

This application claims priority benefits to Chinese Patent Application No. 2024115331496, filed on Oct. 30, 2024, the contents of which are incorporated herein by reference.

### TECHNICAL FIELD

present invention is relevant to technical field of automotive parts, especially A support assembly for an embedded rear cover

### BACKGROUND TECHNOLOGY

Pickup trucks, as a common type of vehicle, offer car-like comfort without losing power. Due to its strong cargo carrying and adaptability to poor road conditions and its strong overall performance, pickup trucks have become one of the most common off-road vehicles nowadays. In order to adapt to more diverse environments, most existing pickup trucks need to be fitted with a car cover, which is made of a plurality of panels spliced together. When in use, the car cover will be folded, however the folding step of the existing car cover is complicated, and the support is not stable when the folded state is kept folded open after folding.

### About the Invention

The embodiment in present invention provides a support structure for an embedded rear cover, which at least solves the technical problem of unstable support after the cover is folded and complicated support steps.

In order to solve the above problems of the existing technology, the technical solution adopted in the invention is as follows:

The present application proposes a support assembly for an embedded rear cover, applied to an embedded rear cover, the embedded rear cover is detachably mounted on a rear cargo hopper, the rear cargo hopper is provided with a storage space, the embedded rear cover can be in either a flat state or a folded state, the embedded rear cover in the flat state covers the storage space, the embedded rear cover in the folded state opens the storage space, the embedded rear cover is formed by splicing multiple panels, a rotating shaft joint at the joints of two adjacent panels enables one panel to fold relative to the adjacent panel, allowing them to be either perpendicular or approximately parallel; During the transition of the folded state from the flat state to the folded state, a plurality of panels are sequentially folded along the second direction by a plurality of adapters, a folded body with at least one rotating shaft point is formed at a terminal panel; the support assembly is provided at the rotating shaft point of the folded body, the support assembly comprises at least one of a first support structure and a second support structure to support the folded body at the rotating shaft point of the folded body to maintain its stability with respect to the rear cargo hopper.

The beneficial effect is that: the support assembly provided in the embodiment of the present invention supports both the front side and the rear side of the folded embedded rear cover through the first support structure and the second support structure, respectively, providing comprehensive support to the folded embedded rear cover and enhancing stability; further, through the cooperation of the clamping groove with the first support structure, the process is simplified as the support is achieved by merely securing the clamp surface into the target groove surface, making the support operation more straightforward and suitable for widespread adoption.

Further, the support assembly comprises a first support structure or a second support structure.

Further, the rotating shaft point is arranged at either the side of the folded body or the top surface of the folded body. This arrangement providing comprehensive support to the folded embedded rear cover and enhancing its stability . . .

Further, the embedded rear cover further comprises a guide rail arranged along the second direction, the guide rail is provided with a clamping groove, a target surface is provided on a peripheral or extension surface of the clamping groove of the guide rail; the first support structure comprises a supporting rod with a certain length, one end of the supporting rod is mounted at a rotating shaft point of the folded body by a Mounting seat, while the other end of the supporting rod is provided with at least one clamping surface, which is clamped to the target surface, the supporting rod is provided to support the front side of the folded body. With this setting, the clamping surface engages with the target surface, ensuring that the supporting rod maintains the supporting state of the folded body.

Further, the first support structure further comprises a first restricting clamp mounted on the outer wall of the supporting rod, the bottom surface of the first restricting clamp is a first clamping surface, the first clamping surface is clamped to the surface to be clamped. With this setting, the first restricting clamp restricts the supporting rod so that the supporting rod has a support height.

Further, the first support structure further comprises a second restricting clamp mounted on the outer wall of the supporting rod and located below the first restricting clamp, the top surface of the second restricting clamp is the second clamping surface, the supporting rod located between the first clamping surface and the second clamping surface is the first clamping rod. With this setting, the bottom of the clamping groove can be limited to prevent the embedded rear cover from being lifted over in case of windy weather, thereby making the support more stable.

Further, the first support structure further comprises a third restricting clamp mounted at the end of the supporting rod and located below the second restricting clamp, the bottom surface of the second restricting clamp is a third clamp surface, the top surface of the third restricting clamp is a fourth clamp surface, the supporting rod located between the third clamp surface and the fourth clamp surface is the second clamp rod. With this setting, any single restricting clamp can be engaged with the clamping groove, thereby adjusting support heights to meet different support requirements.

Further, the first support structure further comprises a clamp head, which is located between the mounting seat and the supporting rod for adjusting the angle of the supporting rod. This setting makes it more convenient and flexible for the embedded rear cover to switch between the flat state and the folded state.

Further, the clamping groove is a recess. The design of the recess allows the support bar to enter through the gap of the groove and lock at the closed end of the groove.

Further, a sliding groove is provided along the length direction of the guide rail, a supporting block, is provided in a sliding groove at a position corresponding to the clamp groove. This setting enables the supporting block, to support the guide rail at the force, which locally improves the rigidity of the guide rail, thereby preventing the guide rail from deformation under localized compression.

Further, the guide rail further provides an extension surface along the horizontal direction; the supporting block, comprises a guiding part and a supporting part, the supporting part is provided with a supporting surface; the guiding part is connected to the lower surface of the guide rail, the supporting surface supports the extension surface. This setting improves the rigidity of the guide rail locally by supporting the extension surface with the supporting surface.

Further, the guiding part is slidingly connected with the sliding groove, the front side of the supporting part is provided with an extension part, both the supporting part and the extension part are provided with a supporting surface for supporting the extension surface. By extending the supporting range of the supporting part, the supporting effect is improved, thereby enhancing the local rigidity of the guide rail.

Further, the extension part is provided with a U-shaped groove. The U-shaped groove is adapted to the supporting rod, allowing the supporting rod 33 to pass through.

Further, it further comprises a fixing clamp, which secures the first support structure before folding. The fixing clamp holds the first support structure in place to prevent it from shifting during travel.

Further, the folded body is provided with a fixing section and a folding section, the fixing section is arranged along the first direction, the folding section is arranged along the third direction, a second support structure is provided between the fixing section and the folding section to maintain the relative position of the folding section to the fixing section. With this setting, the second support structure supports the folding section to prevent any positional or angular deviation of the folding par of the folding section.

Further, a second support structure is provided to support the rear side of the folding section corresponding to the fixing section. With this setting, the second support structure blocks or supports the rear side of the folding section to enhance solidity.

Further, the second support structure comprises a fixing seat, the top of the fixing seat is provided with a cushion pad, which has at least one blocking surface facing the folding section to block or support the rear side of the folding section. Multiple blocking surfaces are arranged to support the folding section in multiple positions to enhance the solidity of the support.

### DESCRIPTION OF FIGURE

FIG. 1 is an assembly diagram of an embedded rear cover in a flat state and a car rear cargo hopper provided by the embodiment in present invention;

FIG. 2 is a top view of the embedded rear cover in present invention in the flat state;

FIG. 3 is a schematic diagram of one embodiment of the first support structure in present invention;

FIG. 4 is a schematic diagram of another embodiment of the first support structure in present invention;

FIG. 5 is an assembly diagram of the first support structure and the guide rail in present invention;

FIG. 6 is a partial detail diagram of the first support structure in present invention;

FIG. 7 is a first view three-dimensional diagram of the embedded rear cover and the rear box of the vehicle body in a folded state in present invention;

FIG. 8 is an enlarged view of part A in FIG. 7;

FIG. 9 is a partial detail view of the first support structure of the embodiment in present invention with a guide rail of one of the embodiments in present invention;

FIG. 10 is a three-dimensional view of one embodiment of the guide rail in present invention;

FIG. 11 is a side view of one of the embodiments of the guide rail in present invention;

FIG. 12 is a schematic view of one embodiment of the supporting block, in present invention;

FIG. 13 is a second perspective three-dimensional view of an embedded rear cover in a folded state and a rear cargo hopper of an embodiment in present invention;

FIG. 14 is an enlarged view of part B in FIG. 13;

FIG. 15 is a partial detail view of a first support structure of an embodiment in present invention with a guide rail of another embodiment;

FIG. 16 is a three-dimensional view of another embodiment of the guide rail in present invention;

FIG. 17 is a side view of another embodiment of the guide rail in present invention;

FIG. 18 is a schematic view of another embodiment of the supporting block, in present invention;

FIG. 19 is a three-dimensional view of a fixing clamp of an embodiment in present invention;

FIG. 20 is a third perspective three-dimensional view of an embodiment in present invention in a folded state with an embedded rear cover and a rear cargo hopper;

FIG. 21 is a three-dimensional view of a second support structure of an embodiment in present invention;

FIG. 22 is a side view of an embedded rear cover with a rear cargo hopper in a folded state of an embodiment in present invention;

FIG. 23 is an enlarged view of part C of FIG. 22;

FIG. 24 is a schematic view of a supporting frame;

FIG. 25 is a splicing schematic diagram of the guide rail.

### FIGURES

1. Rear cargo hopper;
2. Embedded rear cover.
21. Panels, 211. Front panel, 212. First intermediate panel, 213. Second intermediate panel, 214. Rear panel;
22. Adapters, 221. First adapter, 222. Second adapter, 223. Third adapter, Z1, First folding line, Z2, Second folding line, Z3, Third folding line, Z4, Fourth folding line, Z5, Fifth folding line;
3. First support structure, 31. Mounting seat, 32, Clamp head, 33. Supporting rod, 331. First clamping rod, 332. Second clamping rod, 34. First restricting clamp, 341. First clamping surface, 35. Second restricting clamp, 351. Second clamping surface, 352. Third clamping surface, 36. Third restricting clamp, 361. Fourth clamping surface;
4. Guide rail, 41. Clamping groove, 42. Target surface, 43. Sliding groove, 44. Supporting block, 441. Guiding part, 442. Supporting part, 443. Supporting surface, 444. Extension part, 445. U-shaped groove, 45. Extension surface; 4A. Front segment guide rail, 4B. Rear segment guide rail, 4C. Fixing part;
5. Fixing clamp, 51. Clamping section, 52. Clamping groove;
6. Second support structure, 61. Fixing seat, 62. Cushion pad, 621. First blocking surface, 622. Second blocking surface, 623. Third blocking surface;
7. Fixing section;
8. Folding section;
9. Supporting frame;
10. First supporting body;
11. Second supporting body;
D1. First direction, D2. Second direction, D3. Third direction, D4. Fourth direction.

### The Concrete Method to Carry Out

The following instruction further explains the invention's concrete implementation method.

In the description in present invention, it is to be understood that the orientation or positional relationships indicated by the terms “top”, “bottom”, “inside”, “outside”, “top”, “bottom”, “top”, “bottom”, “inside”, “bottom”, “inside”, “outside”, etc. are based on the orientation or positional relationships shown in the accompanying drawings, which serve only to facilitate the description in present invention and simplify the description, and are not to be construed as limiting the present invention in any way as they indicate or imply that the device or element referred to must be constructed and operated with a specific orientation or be constructed and operated in a specific orientation.

The terms “first”, “second”, “third”, etc. are only used to differentiate the description and should not be construed as indicating or implying relative importance. Thus, a feature defined with the terms “first”, “second” may expressly or implicitly include one or more such features. For the purposes of the description in present invention, unless otherwise indicated, “more than one” means two or more.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

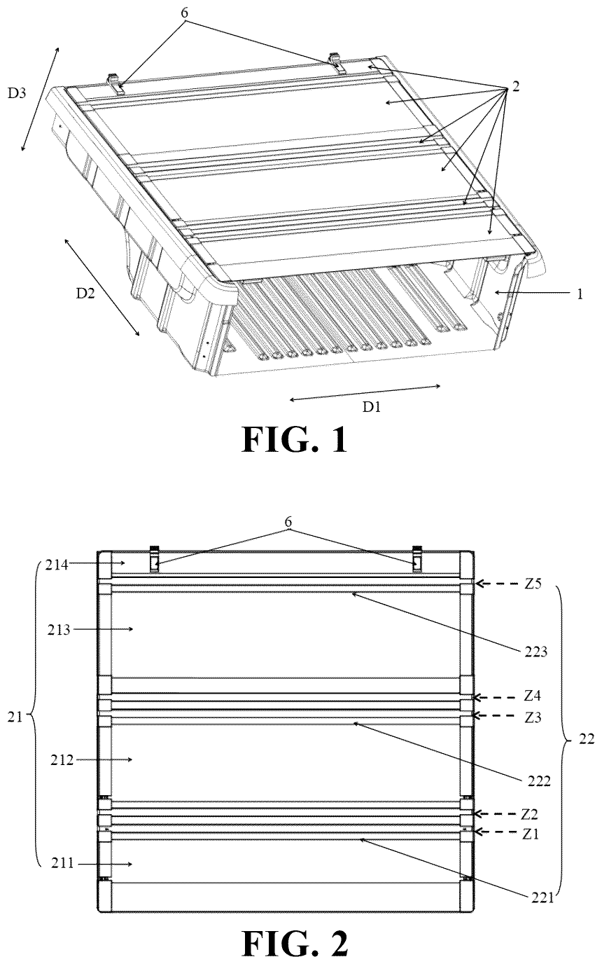

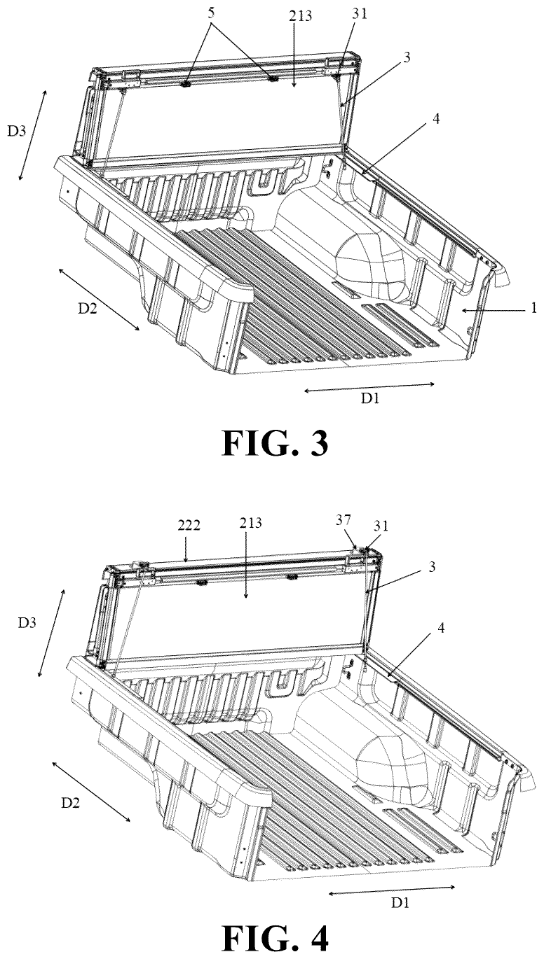

The embodiment of present invention provides a support assembly for an embedded rear cover, see FIG. 1, which is an assembly diagram of an embedded rear cover in a flat state and a car rear cargo hopper provided by the embodiment in present invention, applied to an embedded rear cover 2. An embedded rear cover 2 is detachably mounted on a rear cargo hopper 1, the car rear cargo hopper 1 is provided with a storage space, the embedded rear cover 2 can be in either a flat state or a folded state, the embedded rear cover 2 in a flat state covers the storage space, the folded state embedded rear cover 2 opens the storage space, the embedded rear cover 2 is formed by splicing multiple panels 21, a rotating shaft joint at the joints of two adjacent panels enables one panel to fold relative to the adjacent panel, allowing them to be either perpendicular or approximately parallel. During the transition of the embedded rear cover 2 from a flat state to a folded state, a plurality of the panels 21 are sequentially folded along the second direction by a plurality of adapters 22, and a folded body with at least one rotating shaft point formed at the terminal panel. A support assembly is provided at the rotating shaft point of the folded body, scc FIG. 3, which shows a schematic diagram of the first support structure 3 in present invention; the support assembly comprises at least one of the first support structure 3 and the second support structure 6 to support the folded body at the rotating shaft point to maintain its stability with respect to the rear cargo hopper 1.

A support assembly provided in the embodiment in present invention supports both the front side and the rear side of the folded embedded rear cover 2 through the first support structure 3 and the second support structure 6, respectively, providing comprehensive support to the folded embedded rear cover 2 and enhancing stability, further, through the cooperation of the clamping groove 41 with the first support structure 3, the process is simplified as the support is achieved by merely securing the clamp surface into the target surface 42, making the support operation more straightforward and suitable for widespread adoption

It should be noted that the storage space of the rear cargo hopper1 mentioned above specifically refers to the storage space formed by the rear cargo hopper's floor and the side panels extending upward along the edges of the floor, designed to accommodate objects;

Additionally, it is to be explained that a folded body with at least one rotating shaft point is formed by folding the panel at the terminal panel; the terminal end refers to the side close to the front of the vehicle, with the panels are sequentially folding in the direction from the rear toward the front of the vehicle;

The support assembly comprises cither a first support structure 3 or a second support structure 6.

See FIG. 2, the above mentioned plurality of panels 21 and plurality of adapters 22 are illustrated by way of example hereinafter, FIG. 2 is a top-down view of the embedded rear cover in a flat state of the embodiment in present invention. In the embodiment of present invention, a plurality of panels 21 are a front panel 211, a first intermediate panel 212, a second intermediate panel 213 and a rear panel 214 connected sequentially along the second direction D2, the rear panel 214 is detachably mounted on the rear cargo hopper 1, a plurality of adapters 22 comprises a first adapter 221 rotationally connected between the front panel 211 and the first intermediate panel 212, a second adapter 222 rotationally connected between the first intermediate panel 212 and a second intermediate panel 213, and a third adapter 223 rotationally connected between the second intermediate panel 213 and the rear panel 214, the first adapter 221 is provided with a first folding line Z1 and a second folding line Z2, the second adapter 222 is provided with a third folding line Z3 and a fourth folding line Z4, the third adapter 223 is provided with a fifth folding line Z5, During the transition of the embedded rear cover 2 from the flat state to the folded state, it folds sequentially along the first folding line Z1, the second folding line Z2, the third folding line Z3, the fourth folding line Z4, and the fifth folding line Z5.

See FIG. 3, which illustrates a schematic diagram of one of the embodiments of the first support structure 3 in present invention; the rotating shaft point is arranged at the side of the folded body, providing comprehensive support to the folded embedded rear cover 2 and enhancing its stability.

It should be noted that the second direction D2 is divided into forward and backward directions, the side of the folded body refers to the surface oriented forward in the second direction (D2), i.e., the surface facing away from the front of the vehicle.

See FIG. 4, which illustrates another embodiment of the first support structure 3 in present invention. In this embodiment, the rotating shaft point is arranged on the top surface of the folded structure, providing comprehensive support to the folded embedded rear cover 2 and enhancing its stability. The support points in the two embodiments are located at different heights to meet diverse usage requirements.

Specifically, the support point is arranged on the back surface of a spacer rod installed between panels, i.e., the top surface of the folded body.

It should be noted that the third direction (D3) is divided into upward and downward directions, where the top surface of the folded structure refers to the surface oriented upward in the third direction (D3).

It can be understood that the top surface corresponds to the underside of the hinge, while the side surface corresponds to the underside of the panel (where the panel includes the panel and multiple frames).

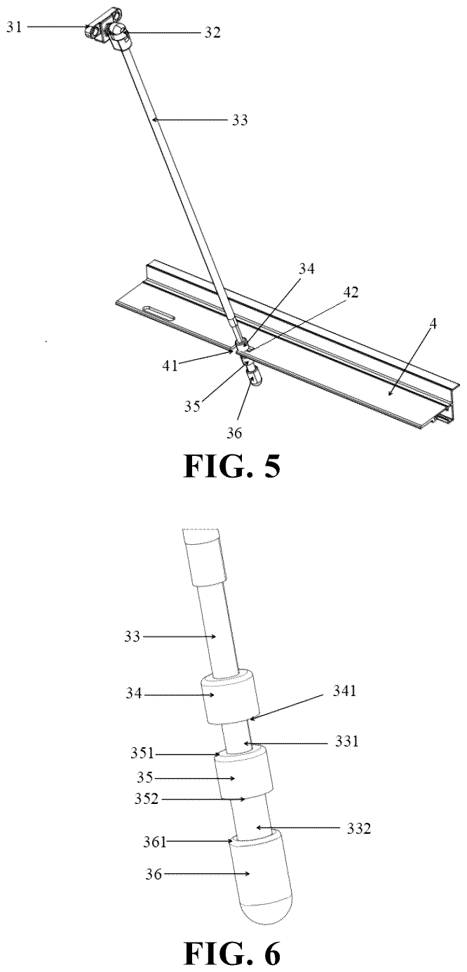

See FIG. 5, which illustrates the assembly diagram of the first support structure 3 and the guide rail 4 in present invention. The embedded rear cover 2 further comprises a guide rail 4 arranged along the second direction, with the guide rail 4 is provided with a clamping groove 41, a target surface 42 is provided on a peripheral or extension surface of the clamping groove 41 of the guide rail 4, the first support structure 3 comprises a supporting rod 33 with a certain length. One end of the supporting rod 33 is mounted at the rotating shaft point of the folded body by a Mounting seat 31, while the other end is provided at least one clamping surface, which is clamped to the target surface42, the supporting rod 33 is provided to support the front side of the folded body. The clamping surface engages with the target surface, ensuring that the supporting rod 33 maintains the supporting state of the folded body.

See FIG. 6, which is a partial detail diagram of the first support structure 3 in the embodiment of the present invention. The first support structure 3 further comprises a first restricting clamp 34 mounted on the outer wall of the supporting rod 33, the bottom surface of the first restricting clamp 34 is a first clamping surface 341, the first restricting clamp 34 can be adjusted vertically, which means the support position is provided with threads. The clamp can be a threaded component, and it can also be an integral welded part with the supporting rod or simply be part of the supporting rod itself. The first clamping surface 341 engages with the target surface 42. The first restricting clamp 34 limits the position of the supporting rod 33, providing a specific support height.

In particular, the first restricting clamp 34 can be adjusted vertically, based on the principle that the first restricting clamp 34 is provided with threads on the support position. Specifically, the clamp can be a threads part, or it can be an integral welded part with the supporting rod, or it can be the supporting rod itself. This application does not provide a specific limitation.

In some embodiments, the first restricting clamp 34 can be adjusted vertically, which actually means that the support is threaded at this position, the first restricting clamp 34 is a clamping part with threads;

In other embodiments, the first restricting clamp 34 can also be an integral welded part with the supporting rod 33;

In yet other embodiments, the first restricting clamp 34 is the supporting rod 33 itself;

The clamp may be an integral piece, or it may be a top and bottom adjustable clamp with threads, or it may be a soft leather sleeve or the like.

Further refer to FIG. 6. The first support structure 3 further comprises a second restricting clamp 35, which is mounted on the outer wall of the supporting rod 33 and located below the first restricting clamp 34. The top surface of the second restricting clamp 35 is the second clamping surface 351, the supporting rod 33 located between the first clamping surface 341 and the second clamping surface 351 is the first clamping rod 331. With this setting, the bottom of the clamping groove 41 can be limited to prevent the embedded rear cover 2 from being lifted over in case of windy weather, thereby making the support more stable.

In some embodiments, the second restricting clamp 35 can be adjusted vertically, which means the support position is provided with threads. The second restricting clamp 35 is a threaded component that locks into the lower surface of the target surface, serving a fixing role.

In other embodiments, the second restricting clamp 35 can also be an integral welded part with the supporting rod 33; in yet other embodiments, the second restricting clamp 35 is the supporting rod 33 itself.

Further refer to FIG. 6, the first support structure 3 further comprises a third restricting clamp 36, which is mounted at the end of the supporting rod 33 and located below the second restricting clamp 35, the bottom surface of the second restricting clamp 35 is the third clamping surface 352, the top surface of the third restricting clamp 36 is the fourth clamping surface 361, the supporting rod 33 located between the third clamping surface 352 and the fourth clamping surface 361 is the second clamping rod 332. any single restricting clamp can be engaged with the clamping groove 41, thereby adjusting the support height to meet different support requirements.

It should be noted that the third restricting clamp 36 is also a threaded component. It can engage with either the front or bottom surface of the target surface 42, it can also limit the position of the second restricting clamp 35 to prevent displacement and looseness.

Further refer to FIG. 5, the first support structure 3 further comprises a clamp head 32, which is located between the mounting seat 31 and the supporting rod 33 for adjusting the angle of the supporting rod 33. This setting makes it more convenient and flexible for the embedded rear cover 2 to switch between the flat state and the folded state.

Further refer to FIG. 5, the clamping groove 41 is a recess. The design of the recess allows the supporting rod to enter through the gap of the clamping groove and lock at the closed end of the groove.

Specifically, the clamping groove 41 can be an L-shaped groove, a straight groove, or a circular groove, with the L-shaped groove being preferred. The design of the L-shaped groove allows the supporting rod 33 to pass through one end of the L-shaped groove and lock at the other end of the L-shaped groove.

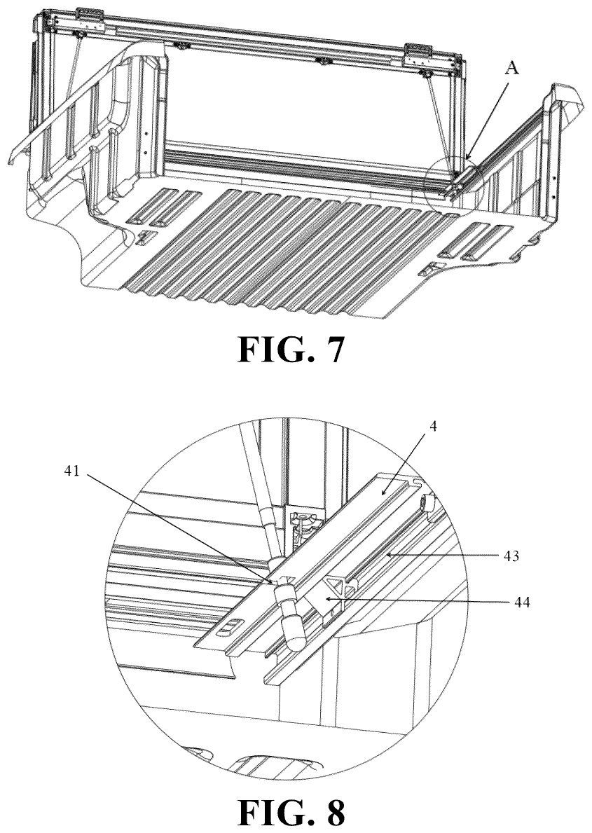

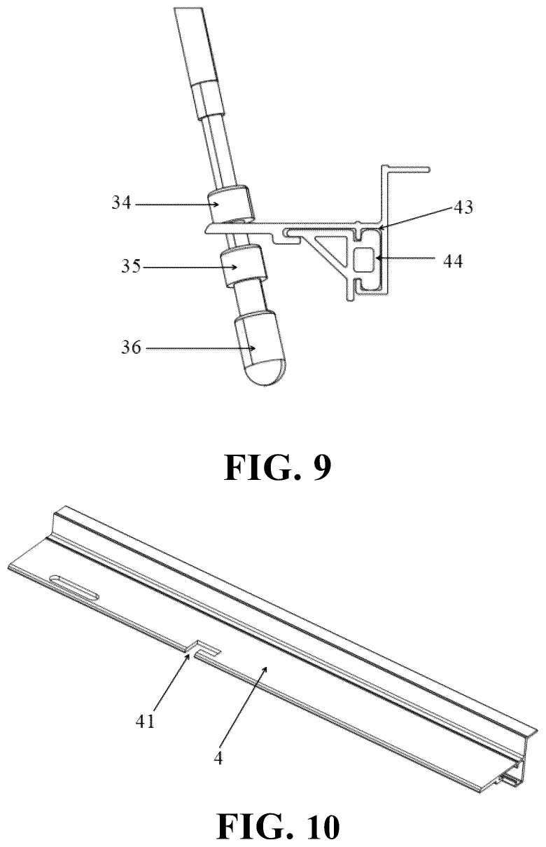

Refer to FIGS. 7-10, where a sliding groove 43 is provided along the length direction of the guide rail 4, a supporting block, 44 is provided inside the sliding groove 43. Specifically, the position of the sliding groove 43 corresponds to the position of the clamping groove 41, a supporting block, 44 is provided support at the force application points of the guide rail 4, locally improves the rigidity of the guide rail 4, thereby preventing the guide rail from deformation caused by localized compression.

It should be noted that the guide rail 4 is equipped with a clamping plate, and the clamp acts on the clamping plate to connect the guide rail 4 with the rear cargo hopper, the clamping plate extends into the rear cargo hopper, a supporting block, 44 is connected between the underside of the clamping plate and the lower surface of the extending plate. One side of the supporting block, 44 is in contact with the clamping plate, while the other side is in contact with the lower surface of the extending plate. This supporting block, 44 can either be fixed and non-detachable or detachable. The reason it can be non-detachable is that the supporting block, can be directly designed as a triangular inclined surface on the aluminum profile.

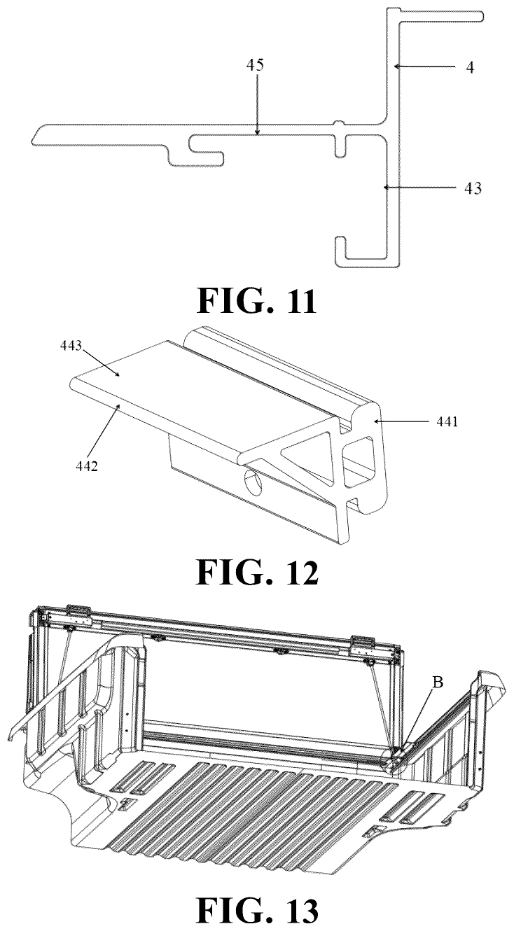

Refer to FIGS. 11 and 12, the guide rail 4 further provides an extension surface 45 along the horizontal direction. The supporting block, 44 comprises a guiding part 441 and a supporting part 442. The supporting part 442 is provided with a supporting surface 443. The lower surface of the guide rail 4 is in contact with the supporting surface 443, which provides support for the extension surface 45. By supporting the extension surface 45 with the supporting surface 443, the local rigidity of the guide rail 4 is enhanced.

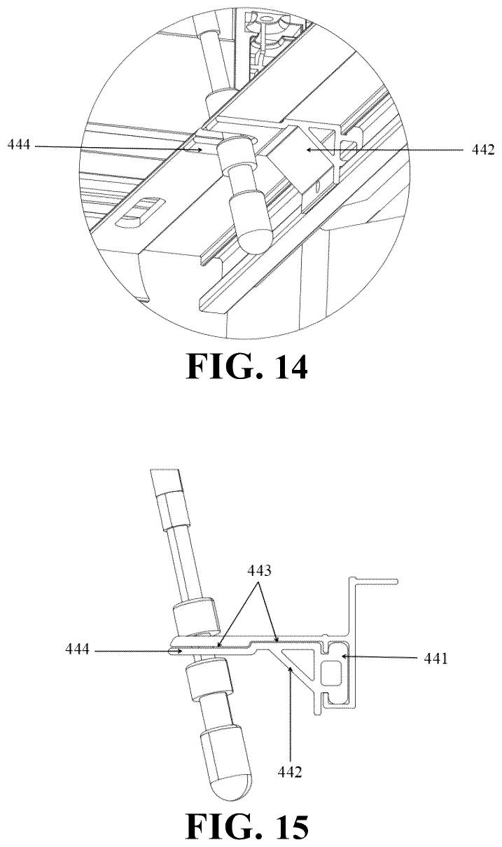

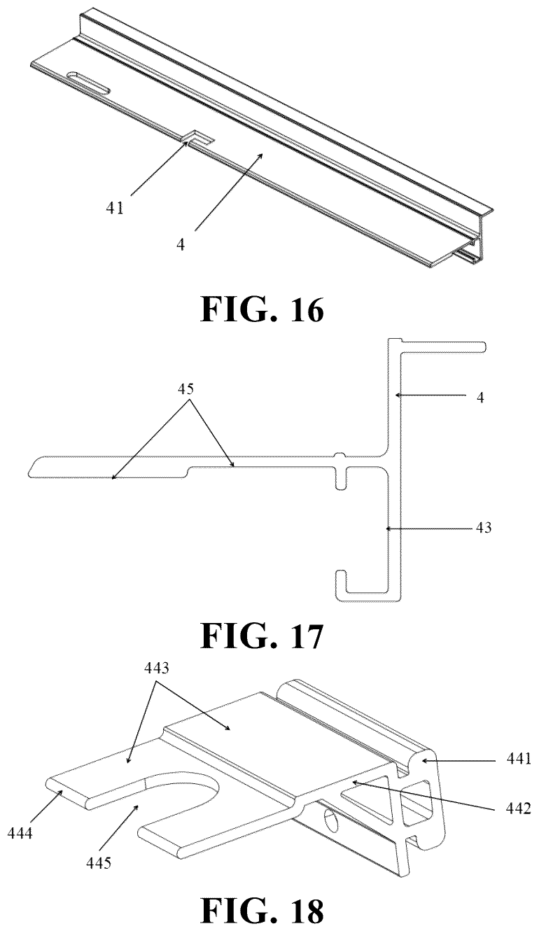

Refer to FIGS. 13-17, the guiding part 441 is slidably connected with the sliding groove 43, the front side of the supporting part 442 is provided with an extension part 444. Both the supporting part 442 and the extension part 444 are provided with a supporting surface 443, which supports the extension surface 45. By extending the supporting range of the supporting part 442, the supporting effect is improved, thereby enhancing the local rigidity of the guide rail 4.

Optionally, as shown in FIG. 25, one side of the guide rail 4 can be divided into a front segment guide rail 4A and a rear segment guide rail 4B, with the front segment guide rail 4A and rear segment guide rail 4B connected by a fixing part 4C.

Refer to FIG. 18, the extension part 444 is provided with a U-shaped groove 445. The U-shaped groove 445 is adapted to the supporting rod 33, allowing the supporting rod 33 to pass through.

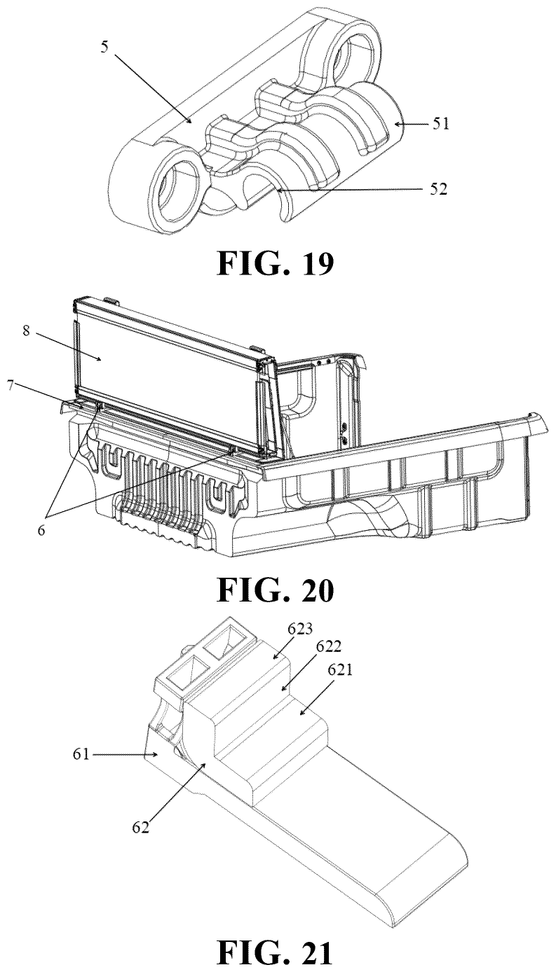

Refer to FIG. 19, it further comprises a fixing clamp 5, which secures the first support structure 3 before folding. The fixing clamp 5 holds the first support structure 3 in place to prevent it from shifting during travel.

Refer to FIG. 20, the folded body is provided with a fixing section 7 and a folding section 8. The fixing section 7 is arranged along the first direction D1, the folding section 8 is arranged along the third direction D3. A second support structure 6 is provided between the fixing section 7 and the folding section 8 to maintain the relative position of the folding section 8 to the fixing section 7. The second support structure 6 supports the folding section 8, preventing any positional or angular deviation of the folding section 8.

Further refer to FIG. 20, the second support structure 6 is provided to support the rear side of the folding section 8 corresponding to the fixing section 7, enhancing stability.

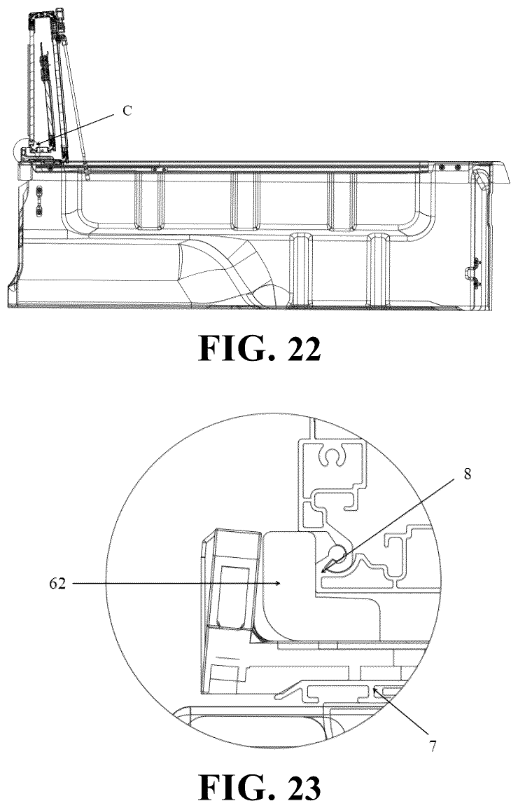

Refer to FIGS. 21-23, the second support structure 6 comprises a fixing seat 61, the top of the fixing seat 61 is provided with a cushion pad 62, which has at least one blocking surface facing the folding section 8 to block or support the rear side of the folding section 8. Multiple blocking surfaces are arranged to support the folding section in multiple positions to enhance the solidity of the support

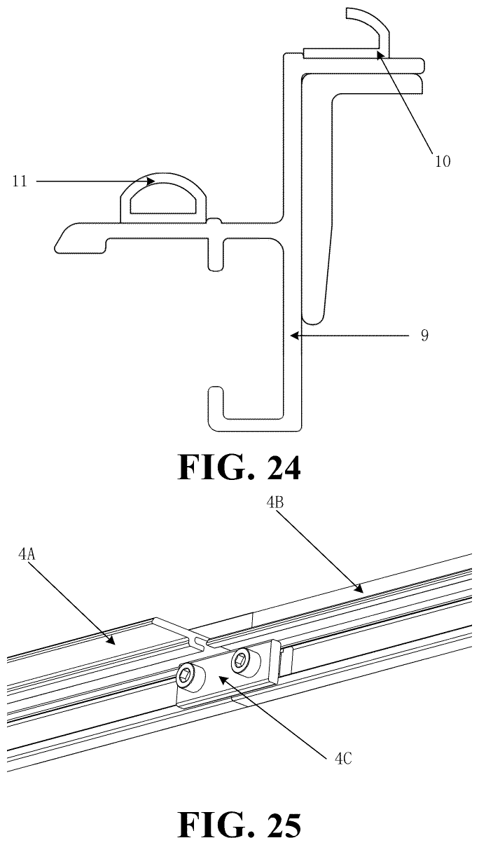

Refer to FIG. 24, a supporting frame 9 is provided between the embedded rear cover 2 and the rear cargo hopper 1 in the flat state, the supporting frame 9 has two support heights. a first supporting body 10 is provided at one of the supporting heights, and a second supporting body 11 is provided at the other supporting height, the second supporting body 11 is made of rubber material, providing cushioning and shock absorption for the embedded rear cover 2.

In the description of this specification, specific features, structures, materials, or characteristics may be combined in any one or more embodiments or examples in a suitable manner.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. A support assembly for an embedded rear cover, applied to an embedded rear cover (2), wherein the embedded rear cover (2) is detachably mounted on a rear cargo hopper (1), the rear cargo hopper (1) is provided with a storage space, the embedded rear cover (2) can be in either a flat state or a folded state, the embedded rear cover (2) in the flat state covers the storage space, the embedded rear cover (2) in the folded state opens the storage space. It characterized in that:
The embedded rear cover (2) is formed by splicing multiple panels (21), a rotating shaft joint at the joints of two adjacent panels (21) enables one panel to fold relative to the adjacent panel (21), allowing them to be either perpendicular or approximately parallel;
During the transition of the embedded rear cover (2) from the-flat state to the folded state, a plurality of panels (21) are sequentially folded along the second direction by a plurality of adapters (22) and a folded body with at least one rotating shaft point formed at a terminal panel (21);
The support assembly is provided at the rotating shaft point of the folded body, the support assembly comprises at least one of the first support structure (3) and the second support structure (6) to support the folded body at the rotating shaft point to maintain its stability with respect to the rear cargo hopper (1)

2. A support assembly for an embedded rear cover according to claim 1, characterized in that the support assembly comprises a first support structure (3) or a second support structure (6).

3. A support assembly for an embedded rear cover according to claim 2, characterized in that the rotating shaft point is arranged at either the side of the folded body or the top surface of the folded body.

4. A support assembly for an embedded rear cover according to claim 3, characterized in that the embedded rear cover (2) further comprises a guide rail (4) disposed along a second direction (D2), the guide rail (4) is provided with a clamping groove (41), a target surface (42) is provided on a peripheral or extension surface of the clamping groove (41) of the guide rail (4);
The first support structure (3) comprises a supporting rod (33) with a certain length, one end of the supporting rod (33) is mounted at a rotating shaft point of the folded body by a Mounting seat (31), while the other end of the supporting rod is provided with at least one clamping surface, which is clamped to the target surface (42), the supporting rod (33) is provided to support the folded body.

5. A support assembly for an embedded rear cover according to claim 4, characterized in that: one side of the guide rail (4) is provided with a front segment guide rail (4A) and a rear segment guide rail (4B) of different cross-sections, the front segment guide rail (4A) and the rear segment guide rail (4B) are connected by means of a fixing member.

6. A support assembly for an embedded rear cover according to claim 4, characterized in that the first support structure (3) further comprises a first restricting clamp (34) mounted on the outer wall of the supporting rod (33), the bottom surface of the first restricting clamp (34) is a first clamping surface (341), the first clamping surface (341) is clamped to the target surface (42).

7. A support assembly for an embedded rear cover according to claim 6, characterized in that the first support structure (3) further comprises a second restricting clamp (35) mounted at the outer wall of the supporting rod (33) and located below the first restricting clamp (34), the top surface of the second restricting clamp (35) is a second clamping surface (351), the supporting rod (33) located between the first clamping surface (341) and the second clamping surface (351) is a first clamping rod (331).

8. A support assembly for an embedded rear cover according to claim 7, characterized in that the first support structure (3) further comprises a third restricting clamp (36) mounted at the end of the supporting rod (33) and located below the second restricting clamp (35), the bottom surface of the second restricting clamp (35) is a third clamping surface (352), the top surface of the third restricting clamp (36) is a fourth clamping surface (361), the supporting rod (33) located between the third clamping surface (352) and the fourth clamping surface (361) is the second clamping rod (332).

9. A support assembly for an embedded rear cover according to claim 2, characterized in that the first support structure (3) further comprises a clamp head (32), the clamp head (32) is located between the mounting seat (31) and the supporting rod (33) for adjusting the angle of the supporting rod (33).

10. A support assembly for an embedded rear cover according to claim 4, characterized in that the clamping groove (41) is a recess.

11. A support assembly for an embedded rear cover according to claim 1, characterized in that a sliding groove (43) is provided along the length direction of the guide rail (4), a supporting block, (44) is provided in the sliding groove (43).

12. A support assembly for an embedded rear cover according to claim 11, characterized in that The guide rail (4) further provides with an extension surface (45) along the horizontal direction;
The supporting block, (44) comprises a guiding part (441) and a supporting part (442), the supporting part (442) is provided with a supporting surface (443);
The guiding part (441) is connected to the lower surface of the guide rail (4), the supporting surface (443) supports the extension surface (45).

13. A support assembly for an embedded rear cover according to claim 12, characterized in that the guiding part (441) is slidingly connected with the sliding groove (43), the extension part (444) is provided on the front side of the supporting part (442), both the supporting part (442) and the extension part (444) are provided with a supporting surface (443) for supporting the extension surface (45).

14. A support assembly for an embedded rear cover according to claim 13, characterized in that the extension part (444) is provided with a U-shaped groove (445).

15. A support assembly for an embedded rear cover according to claim 14, characterized in that it further comprises a fixing clamp (5), which secures the first support structure 3 before folding.

16. A support assembly for an embedded rear cover according to claim 1, characterized in that the folded body is provided with a fixing section (7) and a folding section (8), the fixing section (7) is arranged along the first direction (D1), the folding section (8) is arranged along the third direction (D3), a second support structure (6) is provided between the fixing section (7) and the folding section (8) to maintain the relative position of the folding section (8) to the fixing section (7).

17. A support assembly for an embedded rear cover according to claim 16, characterized in that a second support structure (6) is provided to support the rear side of that folding section (8) at the fixing section (7) corresponding to the folding section (8).

18. A support assembly for an embedded rear cover according to claim 17, characterized in that the second support structure (6) comprises a fixing seat (61), the top of the fixing seat (61) is provided with a cushion pad (62), the surface of the cushion pad (62) towards the folding section (8) is provided with at least one blocking surface to support the rear side of the folding section (8).
